(19) United States
(12) Patent Application Publication
(10) Pub. No.: US 2009/0280297 A1
(43) Pub. Date: Nov. 12, 2009

(54) PAPER PRODUCT WITH VISUAL SIGNALING UPON USE

(76) Inventors: Rebecca Howland Spitzer, Springfield Twp., OH (US); Ward William Ostendorf, West Chester, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/116,288

(22) Filed: May 7, 2008

(51) Int. Cl. B32B 3/02

(52) U.S. Cl. 428/141

(57) ABSTRACT

A ply of a fibrous structure product that has a continuous first pillow region, and a plurality of discrete densified regions. At least one of the plurality of discrete densified regions forms a continuous hollow border area with a plurality of discrete second pillow regions. At least one of the discrete second pillow regions is disposed in the hollow border area and the area of the discrete densified region is from about 0.006 in² to about 0.010 in². The area of the second pillow region is from about 5% to about 50% of the area of the discrete densified region.

### FIELD OF THE INVENTION

The present invention relates to fibrous structure products, more specifically embossed multi-ply fibrous structure products having an enhanced appearance upon use.

### BACKGROUND OF THE INVENTION

Cellulosic fibrous structures are a staple of everyday life. Cellulosic fibrous structures are used as consumer products for paper towels, toilet tissue, facial tissue, napkins, and the like. The large demand for such paper products has created a demand for improved versions of the products and the methods of their manufacture.

Some consumers prefer embossed cellulosic fibrous structure products that have a softer, more three-dimensional, quilted appearance. Many consumers also appreciate products that change appearance during use. For example, it is known to provide a paper towel-type product that may change color when the paper towel comes into contact with bacteria. Such attributes, however, must be provided without sacrificing the other desired functional qualities of the product such as softness, absorbency, drape (flexibility/limpness) and bond strength between the plies.

Paper towels of the prior art often rely on a thick and quilted appearance to provide the consumer with an indication of the absorbency of the product. Many producers use techniques such as embossing to impart a quilted appearance onto a product and to improve the physical attributes of the product. For example, embossing provides the surface of the cellulosic fibrous structure with a highly desirable quilted appearance, and may also have a positive impact on the functional attributes of absorbency, compressibility, and bulk of the cellulosic fibrous structure. However, it is known to those of skill in the art that upon use (i.e., after being wet) the embossed features collapse, thus changing the appearance of the resultant paper product so that it no longer appears to be quilted. Other methods, such as using a patterned belt during production, provides features which maintain their structural integrity during use.

The present invention unexpectedly provides a fibrous structure product surface features that change appearance upon use, but does so in a way that provides consumers with a visual impression of the highly-absorbent nature of the product.

### SUMMARY OF THE INVENTION

In one embodiment, the present invention is directed to a ply of a fibrous structure product comprising: a continuous first pillow region, a plurality of discrete densified regions; wherein a first of the plurality of discrete densified regions forms a continuous hollow border area having at least one discrete second pillow region in the hollow border area; wherein the area of the first discrete densified region is from about 0.006 in² to about 0.010 in²; and wherein the area of the second pillow region has an area of from about 5% to about 50% of the area of the first discrete densified region.

In another embodiment, the present invention is directed to a ply of a fibrous structure product comprising: a continuous first densified region, a plurality of discrete pillow regions; wherein a first of the plurality of discrete pillow regions forms a continuous hollow border area having at least one discrete second densified region in the hollow border area; wherein the area of the first discrete pillow region is from about 0.006 in² to about 0.010 in²; and wherein the area of the second densified region has an area of from about 5% to about 50% of the area of the discrete pillow region.

### BRIEF DESCRIPTION OF THE DRAWINGS

FIG. 1A is a sectional top view of an exemplary embodiment of a product according to the present invention.

FIG. 1B is a cross-sectional view of the product of FIG. 1A taken along line 2A-2A.

FIG. 2A is a sectional top view of an exemplary embodiment of a product according to the present invention.

FIG. 2B is a cross-sectional view of the product of FIG. 1A taken along line 2A-2A.

FIG. 3A is a photograph of a top view of an exemplary embodiment of a product according to the present invention.

FIG. 3B is a photograph of a top view of the product for FIG. 3A after being wet.

FIG. 4A is a photograph of a top view of an exemplary embodiment of a product according to the prior art.

FIG. 4B is a photograph of a top view of the product for FIG. 4A after being wet.

FIG. 5A is a photograph of a top view of an exemplary embodiment of a product according to the prior art.

FIG. 5B is a photograph of a top view of the product for FIG. 5A after being wet.

### DETAILED DESCRIPTION OF THE INVENTION

“Paper product”, as used herein, refers to any formed fibrous structure product, which may, but not necessarily, comprise cellulose fibers. In one embodiment, the paper products of the present invention include tissue-towel paper products.

“Tissue-towel paper product”, as used herein, refers to products comprising paper tissue or paper towel technology in general, including, but not limited to, conventional felt-pressed or conventional wet-pressed tissue paper, pattern densified tissue paper, starch substrates, and high bulk, uncompacted tissue paper. Non-limiting examples of tissue-towel paper products include toweling, facial tissue, bath tissue, table napkins, and the like.

“Ply” or “Plies”, as used herein, means an individual fibrous structure or sheet of fibrous structure, optionally to be disposed in a substantially contiguous, face-to-face relationship with other plies, forming a multi-ply fibrous structure. It is also contemplated that a single fibrous structure can effectively form two “plies” or multiple “plies”, for example, by being folded on itself. In one embodiment, the ply has an end use as a tissue-towel paper product. A ply may comprise one or more wet-laid layers, air-laid layers, and/or combinations thereof. If more than one layer is used, it is not necessary for each layer to be made from the same fibrous structure. Further, the fibers may or may not be homogenous within a layer. The actual makeup of a tissue paper ply is generally determined by the desired benefits of the final tissue-towel paper product, as would be known to one of skill in the art. The fibrous structure may comprise one or more plies of non-woven materials in addition to the wet-laid and/or air-laid plies.

“Fibrous structure” as used herein means an arrangement of fibers produced in any papermaking machine known in the art to create a ply of paper. “Fiber” means an elongate particulate having an apparent length greatly exceeding its apparent width. More specifically, and as used herein, fiber refers to such fibers suitable for a papermaking process. The present invention contemplates the use of a variety of paper making fibers, such as, natural fibers, synthetic fibers, as well as any other suitable fibers, starches, and combinations thereof. Paper making fibers useful in the present invention include cellulosic fibers commonly known as wood pulp fibers. Applicable wood pulps include chemical pulps, such as Kraft, sulfite and sulfate pulps; mechanical pulps including groundwood, thermomechanical pulp; chemithermomechanical pulp; chemically modified pulps, and the like. Chemical pulps, however, may be preferred in tissue towel embodiments since they are known to those of skill in the art to impart a superior tactical sense of softness to tissue sheets made therefrom. Pulps derived from deciduous trees (hardwood) and/or coniferous trees (softwood) can be utilized herein. Such hardwood and softwood fibers can be blended or deposited in layers to provide a stratified web. Exemplary layering embodiments and processes of layering are disclosed in U.S. Pat. Nos. 3,994,771 and 4,300,981. Additionally, fibers derived from non-wood pulp such as cotton linters, bagesse, and the like, can be used. Additionally, fibers derived from recycled paper, which may contain any or all of the pulp categories listed above, as well as other non-fibrous materials such as fillers and adhesives used to manufacture the original paper product may be used in the present web. In addition, fibers and/or filaments made from polymers, specifically hydroxyl polymers, may be used in the present invention. Non-limiting examples of suitable hydroxyl polymers include polyvinyl alcohol, starch, starch derivatives, chitosan, chitosan derivatives, cellulose derivatives, gums, arabinans, galactans, and combinations thereof. Additionally, other synthetic fibers such as rayon, lyocel, polyester, polyethylene, and polypropylene fibers can be used within the scope of the present invention. Further, such fibers may be latex bonded. Other materials are also intended to be within the scope of the present invention as long as they do not interfere or counter act any advantage presented by the instant invention.

“Basis Weight”, as used herein, is the weight per unit area of a sample reported in lbs/3000 ft² or g/m².

“Machine Direction” or “MD”, as used herein, means the direction parallel to the flow of the fibrous structure through the papermaking machine and/or product manufacturing equipment.

“Cross Machine Direction” or “CD”, as used herein, means the direction perpendicular to the machine direction in the same plane of the fibrous structure and/or fibrous structure product comprising the fibrous structure.

“Embossing” or “embossments”, as used herein, refers to the process of deflecting a portion (e.g. a relatively small portion), of a cellulosic fibrous structure normal to its plane and impacting the projected portion of the fibrous structure against another surface, e.g. a relatively rigid surface, to permanently disrupt the fiber-to-fiber bonds. Exemplary methods of, and apparatus for, embossing are described in U.S. Pat. Pub. No. 2007/0062658A1 and U.S. Pat. Nos. 3,414,459, 4,320,162 and 5,468,323.

“Formed features”, as used herein, refers to a surface feature of a cellulosic fibrous structure product wherein the features are actually formed during the papermaking process. In one embodiment, a present-invention cellulosic fibrous structure product can be formed from an aqueous slurry of papermaking fibers. An exemplary method for making a product having formed features is described as follows: A cellulosic fibrous web is formed at a low fiber consistency on a foraminous member to a differential velocity transfer zone where the web is transferred to a slower moving member such as a loop of open weave fabric to achieve wet-microcontraction of the web in the machine direction without precipitating substantial macrofolding or compaction of the web; and, subsequent to the differential velocity transfer, drying the web without overall compaction and without further material rearrangement of the fibers of the web in the plane thereof. The paper may be pattern densified by imprinting a fabric knuckle pattern into it prior to final drying; and the paper may be creped after being dried. Also, primarily for product caliper control, the paper may be lightly calendared after being dried. A primary facet of the process is to achieve the differential velocity transfer without precipitating substantial compaction (i.e., densification) of the web. Thus, the web is said to be wet-microcontracted as opposed to being wet-compacted or macro-folded or the like. The resulting substrate has one or more plies of fibrous structure wherein at least one of the plies comprises two or more planes formed during the papermaking process wherein each plane is discontinuous from the other planes and wherein at least one of the planes comprises a continuous region. In one embodiment, the cellulosic fibrous structure product of the present invention has a pattern on the surface of the cellulosic fibrous structure product comprising densified regions and pillow regions. The densified regions of the cellulosic fibrous structure product are characterized by a relatively high fiber density. The pillow regions of the fibrous structure product are characterized as a high-bulk field of relatively low fiber density. Additional examples of products, methods and apparatus for making product having formed features are described in U.S. Pat. Nos. 3,301,746, 3,974,025, 4,191,609, 4,637,859, 3,301,746, 3,821,068, 3,974,025, 3,573,164, 3,473,576, 4,239,065, and 4,528,239.

### Configuration of Formed Features

In one embodiment, a cellulosic fibrous structure product comprises a plurality of formed features wherein the formed features comprise a relatively thick (measured in the MD-CD plane) densified region having a relatively large surface area and a relatively small pillow region. It is surprisingly discovered that the formed features of the present invention product provide a dramatically different, and improved, appearance over products in the prior art when the product is used. Without wishing to be limited by theory, it is thought that upon use the pillow region absorbs a relatively high amount of liquid compared to the densified region due to the greater amount of void space in the pillow regions. Also without wishing to be limited by theory, it is also thought that consumers note a strong visual difference (i.e., change in relative contrast) between pillow regions and densified regions because of different levels of relative saturation between pillow and densified regions.

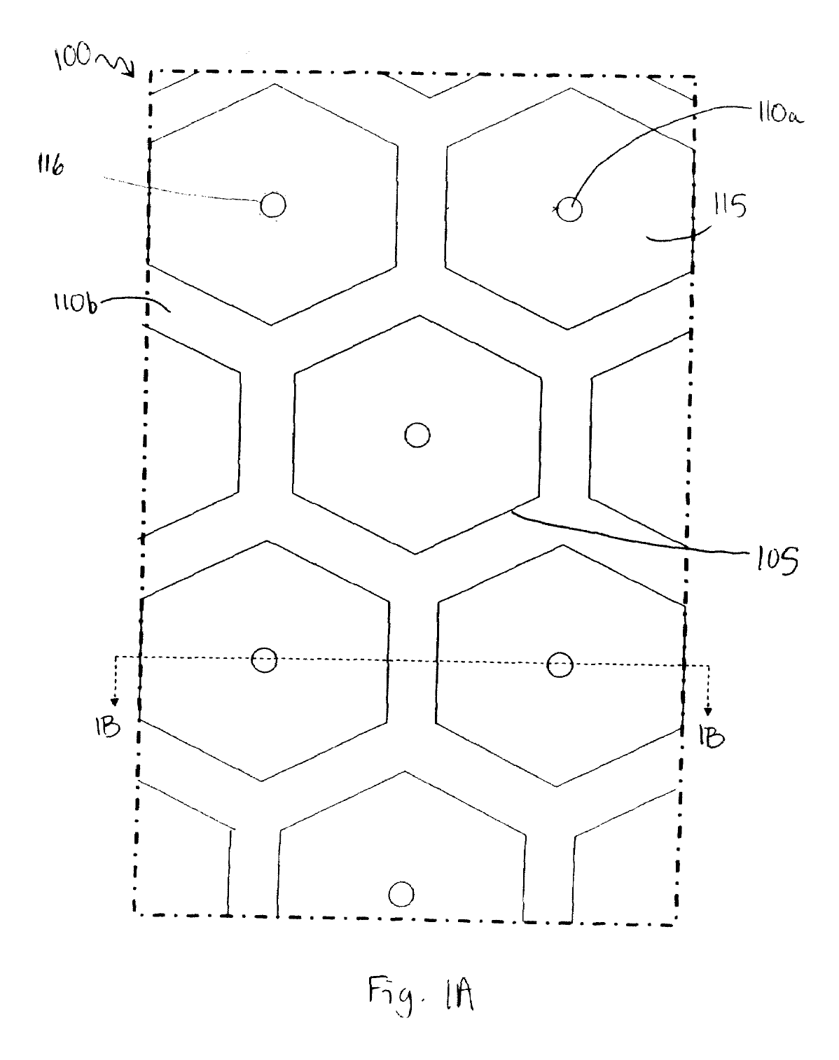

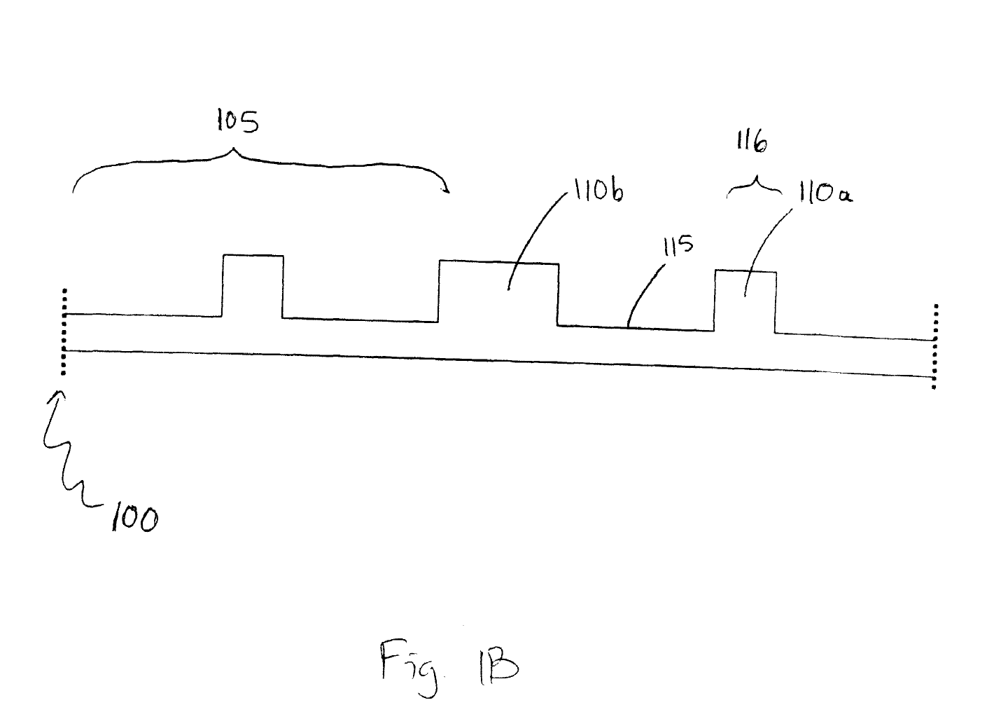

A nonlimiting example of a ply of a fibrous structure product 100 in accordance with the present invention is shown in FIG. 1A. As shown in FIG. 1A a fragmentary top view of a ply of a cellulosic fibrous structure product 100 comprising a plurality of formed features 105. In the exemplary embodiment, the formed features 105 comprise discrete densified regions 115 and one or more second pillow regions 110a. In some embodiments, the discrete densified regions 115 may form a continuous hollow border area 116. In other words, the discrete densified regions 115 may form a continuous area in the MD-CD plane with an empty area (i.e., discontinuity in the densified region) within the border created by the discrete densified regions 115. In the exemplary embodiment, the empty area (hollow border area) is occupied by a second pillow region 110a. In the exemplary embodiment of FIG. 1A, the densified regions 115 are surrounded by a continuous first pillow region 110b. FIG. 1B shows an exemplary embodiment of a cross-sectional view of the fibrous structure paper product 100 of FIG. 1A taken along the line 1B-1B.

In one embodiment the discrete densified regions 115 have an area A_{dens} of from about 0.006 in² to about 0.010 in². In another embodiment, the discrete densified regions 115 have an area A_{dens} of from about 0.004 in² to about 0.015 in². In another embodiment still, the discrete densified regions 115 have an area A_{dens} of from about 0.001 in² to about 0.020 in². In one embodiment, the second pillow region 110a has an area A_{s.p.} of from about 5% to about 50% of the area of the discrete densified regions 115. In one embodiment, the second pillow region 110a has an area A_{s.p.} of from about 10% to about 40% of the area of the discrete densified regions 115. In one embodiment, the second pillow region 110a has an area A_{s.p.} of from about 20% to about 35% of the area of the discrete densified regions 115.

### Alternative Configuration of Formed Features

In an alternative embodiment, a cellulosic fibrous structure product comprises a plurality of formed features wherein the formed features comprise a relatively wide (measured in the MD-CD plane) densified region having a relatively large surface area and a relatively small pillow region.

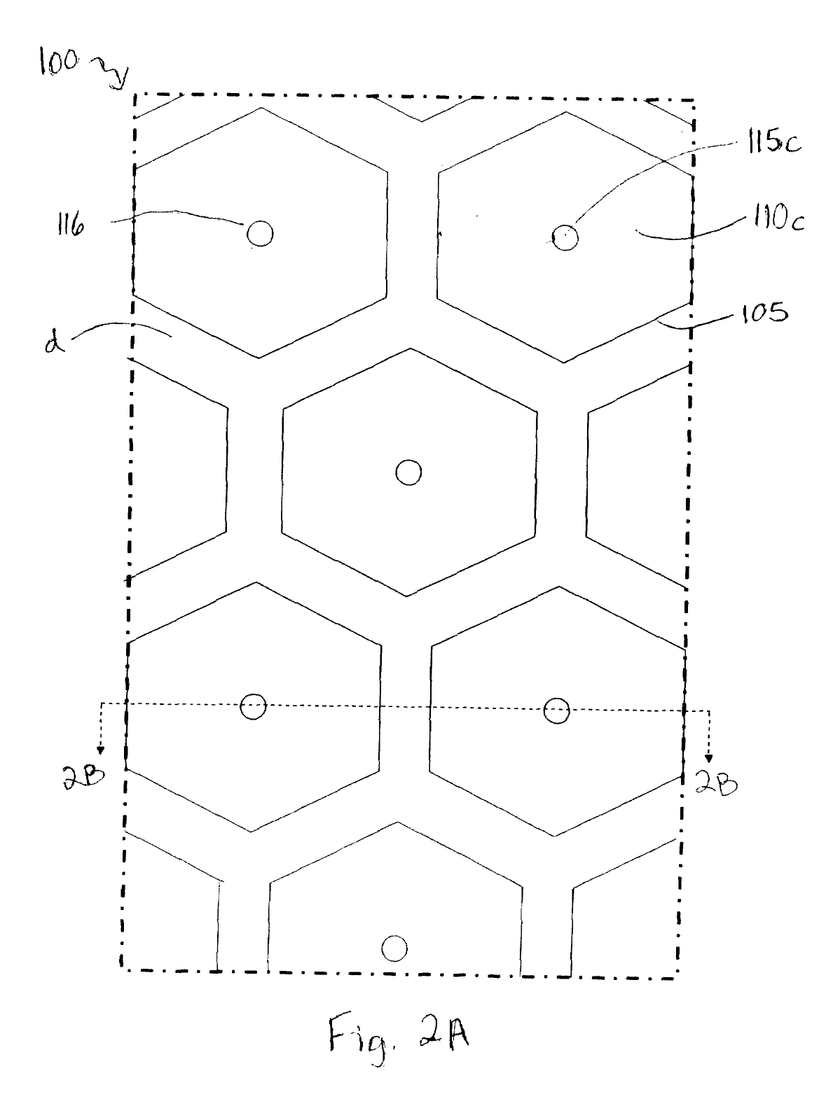

A nonlimiting example of a ply of a fibrous structure product 100 in accordance with the present invention is shown in FIG. 2A. As shown in FIG. 1A a fragmentary top view of a ply of a cellulosic fibrous structure product 100 comprising a plurality of formed features 105. In the exemplary embodiment, the formed features 105 comprise discrete pillow regions 110c and one or more second densified regions 115c. In some embodiments, the discrete pillow regions 110c may form a continuous hollow border area 116. In other words, the discrete pillow areas 110c may form a continuous area in the MD-CD plane with an empty area (i.e., a discontinuity in the pillow region) within the border area created by the discrete pillow regions 110c. In the exemplary embodiment, the empty area (hollow border area) is occupied by a second densified region 115c. In the exemplary embodiment of FIG. 2A, the discrete pillow regions 110c are surrounded by a continuous first densified region 115d. FIG. 2B shows an exemplary embodiment of a cross-sectional view of the fibrous structure paper product 100 of FIG. 1A taken along the line 1B-1B.

In one embodiment the discrete pillow regions 110c have an area A_{dens} of from about 0.006 in² to about 0.010 in². In another embodiment, the discrete pillow regions 110c have an area A_{dens} of from about 0.004 in² to about 0.015 in². In another embodiment still, the discrete pillow regions 110c have an area A_{dens} of from about 0.001 in² to about 0.020 in². In one embodiment, the second densified region 115c has an area A_{s.p.} of from about 5% to about 50% of the area of the discrete pillow regions 110c. In one embodiment, the second densified region 115c has an area A_{s.p.} of from about 10% to about 40% of the area of the discrete pillow regions 110c. In one embodiment, the second pillow region 115c has an area A_{s.p.} of from about 20% to about 35% of the area of the discrete pillow regions 110c.

### Configuration of Formed Features: Visual Signaling Upon Use

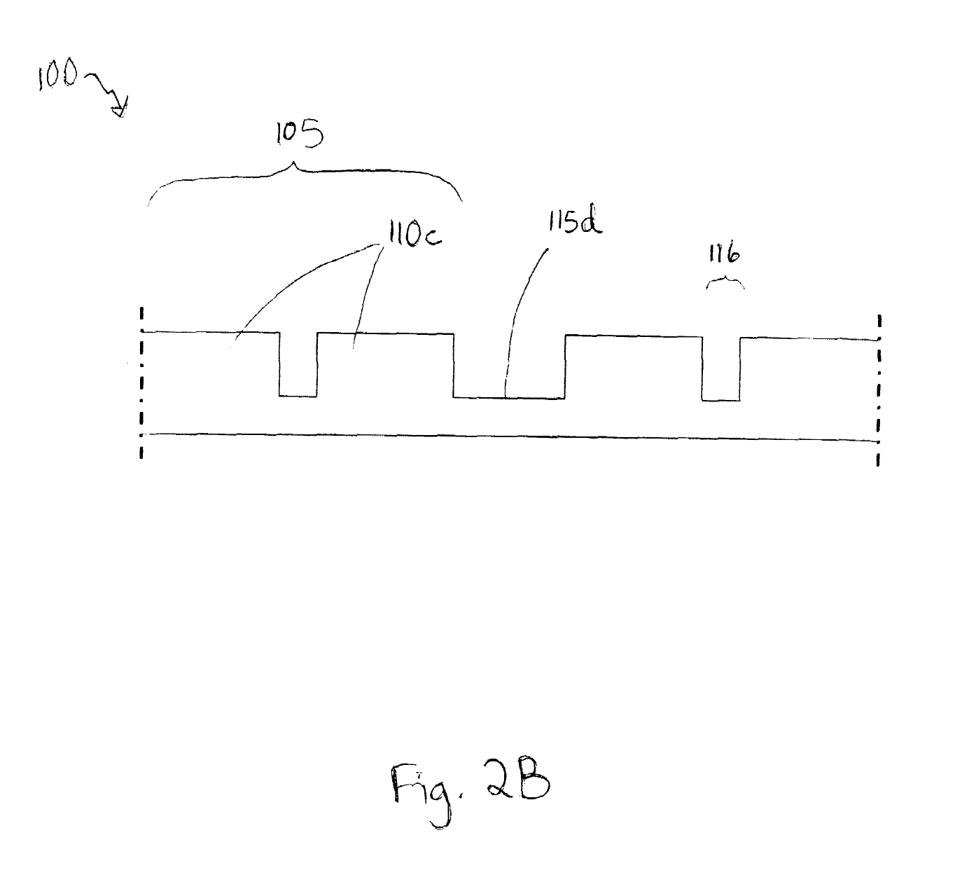

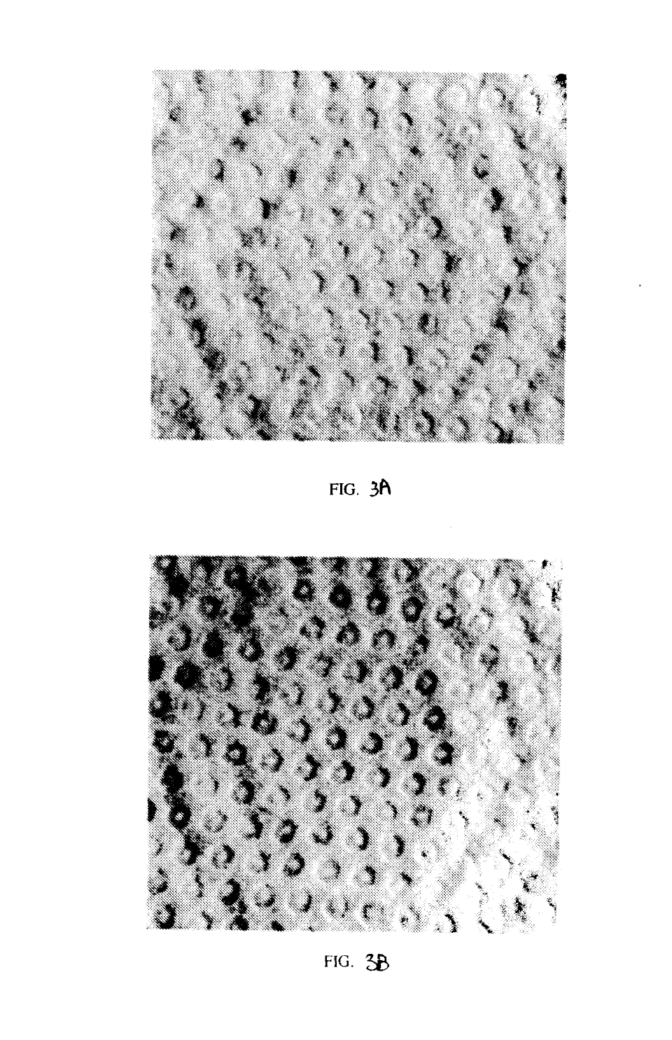

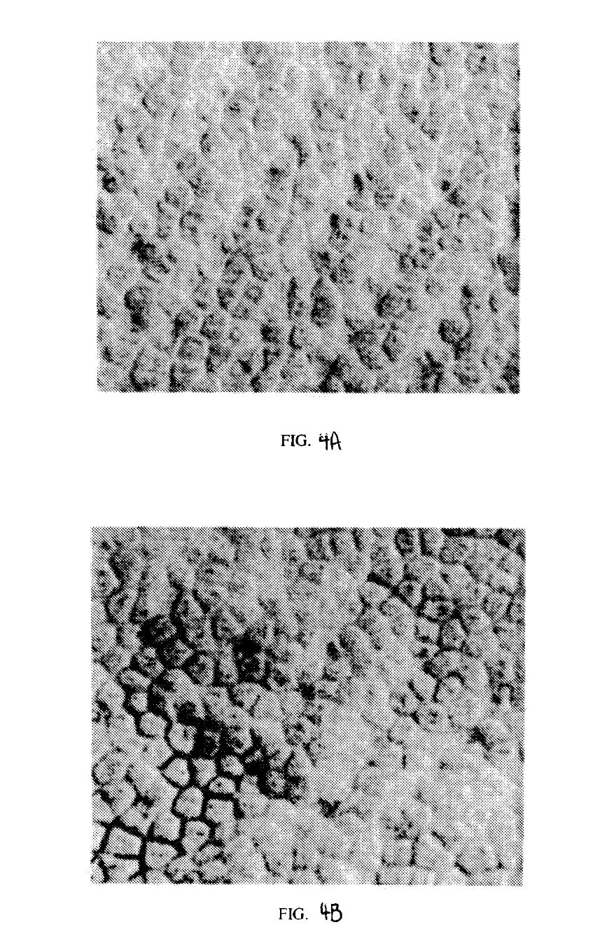

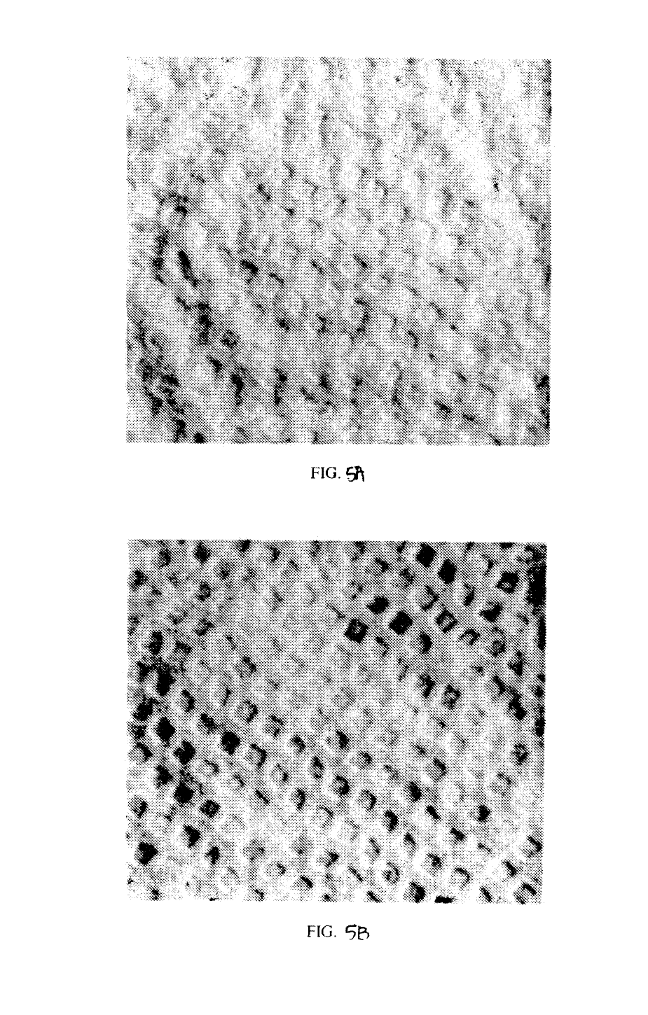

Exemplary papermaking belts which can make structures having continuous pillow regions, discrete densified regions, and discrete second pillow regions are disclosed in U.S. Pat. Nos. 5,556,509 and 5,245,025. However, it was surprisingly discovered that by providing a sufficiently small second pillow region, the resultant product provided users with a very strong visual signaling effect that is not present with a large pillow region. Exemplary embodiments of the present invention product are wet according to the Wetting Test Method described infra. FIGS. 3A-B show an exemplary embodiment of the present invention product before, and after, it has been wet according to the Wetting Test Method. FIGS. 4A-B and FIGS. 5A-B show exemplary embodiments of the exemplary embodiments of prior art product before, and after, they have been wet according to the Wetting Test Method.

The product of FIGS. 3A-B shows a relatively clear change in appearance between the two products whereas prior art products do not show an appreciable change in appearance. Without wishing to be limited by theory, it is thought that if the second pillow regions in FIG. 3A-B are too large in relationship to the discrete densified region, there will not be a visually perceptible difference upon wetting. Further, it is thought that if the formed features are too large, it will be difficult for a consumer to visually perceive a difference in the product upon wetting.

### Paper Product

The present invention is equally applicable to all types of consumer paper products such as paper towels, toilet tissue, facial tissue, napkins, and the like.

The present invention contemplates the use of a variety of paper making fibers, such as, natural fibers, synthetic fibers, as well as any other suitable fibers, starches, and combinations thereof. Paper making fibers useful in the present invention include cellulosic fibers commonly known as wood pulp fibers. Applicable wood pulps include chemical pulps, such as Kraft, sulfite and sulfate pulps, as well as mechanical pulps including, groundwood, thermomechanical pulp, chemically modified, and the like. Chemical pulps may be used in tissue towel embodiments since they are known to those of skill in the art to impart a superior tactical sense of softness to tissue sheets made therefrom. Pulps derived from deciduous trees (hardwood) and/or coniferous trees (softwood) can be utilized herein. Such hardwood and softwood fibers can be blended or deposited in layers to provide a stratified web. Exemplary layering embodiments and processes of layering are disclosed in U.S. Pat. Nos. 3,994,771 and 4,300,981. Additionally, fibers derived from wood pulp such as cotton linters, bagesse, and the like, can be used. Additionally, fibers derived from recycled paper, which may contain any of all of the categories as well as other non-fibrous materials such as fillers and adhesives used to manufacture the original paper product may be used in the present web. In addition, fibers and/or filaments made from polymers, specifically hydroxyl polymers, may be used in the present invention. Non-limiting examples of suitable hydroxyl polymers include polyvinyl alcohol, starch, starch derivatives, chitosan, chitosan derivatives, cellulose derivatives, gums, arabinans, galactans, and combinations thereof. Additionally, other synthetic fibers such as rayon, polyethylene, and polypropylene fibers can be used within the scope of the present invention. Further, such fibers may be latex bonded.

In one embodiment the paper is produced by forming a predominantly aqueous slurry comprising about 95% to about 99.9% water. In one embodiment the non-aqueous component of the slurry used to make the fibrous structure comprises from about 5% to about 80% of eucalyptus fibers by weight. In another embodiment the non-aqueous components comprises from about 8% to about 60% of eucalyptus fibers by weight, and in yet another embodiment from about 12% to about 40% of eucalyptus fibers by weight of the non-aqueous component of the slurry. The aqueous slurry can be pumped to the headbox of the papermaking process.

In one embodiment the present invention may comprise a co-formed fibrous structure. A co-formed fibrous structure comprises a mixture of at least two different materials wherein at least one of the materials comprises a non-naturally occurring fiber, such as a polypropylene fiber, and at least one other material, different from the first material, comprising a solid additive, such as another fiber and/or a particulate. In one example, a co-formed fibrous structure comprises solid additives, such as naturally occurring fibers, such as wood pulp fibers, and non-naturally occurring fibers, such as polypropylene fibers.

Synthetic fibers useful herein include any material, such as, but not limited to polymers, such as those selected from the group consisting of polyesters, polypropylenes, polyethylenes, polyethers, polyamides, polyhydroxyalkanoates, polysaccharides, and combinations thereof. More specifically, the material of the polymer segment may be selected from the group consisting of poly(ethylene terephthalate), poly(butylene terephthalate), poly(1,4-cyclohexylenedimethylene terephthalate), isophthalic acid copolymers (e.g., terephthalate cyclohexylene-dimethylene isophthalate copolymer), ethylene glycol copolymers (e.g., ethylene terephthalate cyclohexylene-dimethylene copolymer), polycaprolactone, poly(hydroxyl ether ester), poly(hydroxyl ether amide), polyesteramide, poly(lactic acid), polyhydroxybutyrate, and combinations thereof.

Further, the synthetic fibers can be a single component (i.e., single synthetic material or a mixture to make up the entire fiber), bi-component (i.e., the fiber is divided into regions, the regions including two or more different synthetic materials or mixtures thereof and may include co-extruded fibers) and combinations thereof. It is also possible to use bicomponent fibers, or simply bicomponent or sheath polymers. Nonlimiting examples of suitable bicomponent fibers are fibers made of copolymers of polyester (polyethylene terephthalate)/polyester (polyethylene terephthalate) otherwise known as “CoPET/PET” fibers, which are commercially available from Fiber Innovation Technology, Inc., Johnson City, Tenn.

These bicomponent fibers can be used as a component fiber of the structure, and/or they may be present to act as a binder for the other fibers present. Any or all of the synthetic fibers may be treated before, during, or after the process of the present invention to change any desired properties of the fibers. For example, in certain embodiments, it may be desirable to treat the synthetic fibers before or during the papermaking process to make them more hydrophilic, more wettable, etc.

These multicomponent and/or synthetic fibers are further described in U.S. Pat. Nos. 6,746,766, 6,946,506, and 6,890,872; and U.S. Pat. Pub. Nos. 2003/0077444A1, 2003/0168912A1, 2003/0092343A1, 2002/0168518A1, 2005/0079785A1, 2005/0026529A1, 2004/0154768A1, 2004/0154767, 2004/0154769A1, 2004/0157524A1, and 2005/0201965A1.

The fibrous structure may comprise any tissue-towel paper product known in the industry. Embodiment of these substrates may be made according U.S. Pat. Nos. 4,191, 4,300, 4,191,609, 4,514,345, 4,528,239, 4,529,480, 4,637,859, 5,245,025, 5,275,700, 5,328,565, 5,334,289, 5,364,504, 5,527,428, 5,556,509, 5,628,876, 5,629,052, 5,637,194, and 5,411,636; EP 677612; and U.S. Pat. Pub. No. 2004/0192136A1.

The tissue-towel substrates may be manufactured via a wet-laid making process where the resulting web is through-air-dried or conventionally dried. Optionally, the substrate may be foreshortened by creping or by wet microcontraction. Creping and/or wet microcontraction are disclosed in commonly assigned U.S. Pat. Nos. 6,048,938, 5,942,085, 5,865,950, 4,440,597, 4,191,756, and 6,187,138.

Conventionally pressed tissue paper and methods for making such paper are known in the art, for example U.S. Pat. No. 6,547,928. One suitable tissue paper is pattern densified tissue paper which is characterized by having a relatively high-bulk field of relatively low fiber density and an array of densified zones of relatively high fiber density. The high-bulk field is alternatively characterized as a field of pillow regions. The densified zones are alternatively referred to as knuckle regions. The densified zones may be discretely spaced within the high-bulk field or may be interconnected, either fully or partially, within the high-bulk field. Processes for making pattern densified tissue webs are disclosed in U.S. Pat. Nos. 3,301,746, 3,974,025, 4,191,609, 4,637,859, 3,301,746, 3,821,068, 3,974,025, 3,573,164, 3,473,576, 4,239,065, and 4,528,239.

Uncompacted, non pattern-densified tissue paper structures are also contemplated within the scope of the present invention and are described in U.S. Pat. Nos. 3,812,000, 4,208,459, and 5,656,132. Uncreped tissue paper as defined in the art are also contemplated. The techniques to produce uncreped tissue in this manner are taught in the prior art. For example, Wendt, et al. in European Patent Application Nos. 0 677 612A2 and 0 617 164 A1.

Uncreped tissue paper, in one embodiment, refers to tissue paper which is non-compressively dried, by through air drying. Resultant through air dried webs are pattern densified such that zones of relatively high density are dispersed within a high bulk field, including pattern densified tissue wherein zones of relatively high density are continuous and the high bulk field is discrete. The techniques to produce uncreped tissue in this manner are taught in the prior art. For example, European Patent Application Nos. 0 677 612A2 and 0 617 164 A1; and U.S. Pat. No. 5,656,132.

Other materials are also intended to be within the scope of the present invention as long as they do not interfere or counteract any advantage presented by the instant invention.

The substrate which comprises the fibrous structure of the present invention may be cellulosic, non-cellulosic, or a combination of both. The substrate may be conventionally dried using one or more press felts or through-air dried. If the substrate which comprises the paper according to the present invention is conventionally dried, it may be conventionally dried using a felt which applies a pattern to the paper as taught in U.S. Pat. No. 5,556,509 and PCT App. No. WO 96/00812. The substrate which comprises the paper according to the present invention may also be through air dried. A suitable through air dried substrate may be made according to U.S. Pat. No. 4,191,609.

In one embodiment, one ply of the fibrous structure product has a basis weight of from about 10 lbs/3000 ft² to about 50 lbs/3000 ft². In another embodiment the basis weight is from about 13 lbs/3000 ft² to about 40 lbs/3000 ft²; in another embodiment the basis weight is from about 20 lbs/3000 ft² and about 35 lbs/3000 ft² and in another embodiment the basis weight is from about 20 lbs/3000 ft² and about 30 lbs/3000 ft².

### Test Methods

The following describe the test methods utilized by the instant application in order to determine the values consistent with those presented herein.

### Wetting Test Method

One ply of the paper towel product is placed on a laminate countertop or similar non-absorbent surface at SATP. About 0.5 ml of water is applied drop-wise to a single area of the towel surface using a 1 mL VWR transfer micropipette (Drummond Scientific, San Francisco, Calif.). The micropipette is held approximately 1 inch above the surface of the towel and the drops are applied at a rate of approximately 1 drop/sec. For the purposes of the present application, images are taken of the paper towel products within 1 minute of being wet using the method described supra.

### EXAMPLE 1

One fibrous structure useful in achieving the embossed paper product of the present invention is a through-air-dried (TAD), differential density structure. Such a structure may be formed by the following process.

A Fourdrinier, through-air-dried papermaking machine is run under the following conditions to produce fibrous structure products of the present invention. A wet-microcontracted fibrous structure product is produced herein, comprising the steps of: first forming an embryonic web from an aqueous fibrous papermaking furnish. A slurry of papermaking fibers is pumped to the headbox at a consistency of about 0.15%. The slurry or furnish of the web comprises sixty five percent (65%) northern softwood kraft (NSK) (i.e., long papermaking fibers) and thirty five percent (35%) chemi-thermal mechanical pulp. A strength additive, Kymene 557H, is added to the furnish at a rate of about 20 pounds per ton (about 10 gms/kg). Kymene is a registered trademark of Hercules Inc, of Wilmington, Del. The web is then forwarded at a first velocity, V₁, on a carrier fabric to a transfer zone having a transfer/imprinting fabric. The water is partially removed from the wet web, by non-compressively removing water from the web to a fiber consistency of from about 10% to about 30%, immediately prior to reaching the transfer zone to enable the web to be transferred to the transfer/imprinting fabric at the transfer zone. Dewatering occurs through the Fourdrinier wire and is assisted by vacuum boxes. The wire is of a configuration having 41.7 machine direction and 42.5 cross direction filaments per cm, available from Asten Johnson known as a “786 wire”.

The web is then transferred to the transfer/imprinting fabric in the transfer zone without precipitating substantial densification of the web. The web is then forwarded, at a second velocity, V₂, on the transfer/imprinting fabric along a looped path in contacting relation with a transfer head disposed at the transfer zone, the second velocity being from about 5% to about 40% slower than the first velocity. Since the wire speed is faster than the transfer/imprinting fabric, wet shortening of the web occurs at the transfer point. Thus, the wet web foreshortening may be about 3% to about 15%.

The transfer/imprinting fabric comprises a framework comprises a photosensitive resin, and a reinforcing element that is a fluid-permeable, woven fabric. The sheet side of the transfer/imprinting fabric consists of a discrete, patterned network of photopolymer resin, each discrete resin element containing a hollow border area. The discrete resin element having a surface area of about 0.020 in² and the hollow border area having an area of from about 0.003 in2. The discrete resin covers about 50% of the surface area of the transfer/imprinting fabric. The polymer resin is supported by and attached to a woven reinforcing element having of 27.6 machine direction and 11.8 cross direction filaments per cm. The photopolymer network rises about 0.43 mm above the reinforcing element.

The web is then adhesively secured to a drying cylinder having a third velocity, V₃. Polyvinyl alcohol creping adhesive is used. The drying cylinder is operated at a range of about 145° C. to about 170° C. or about 157° C., and the dryer, Yankee hoods, are operated at about 120° C. The web is then dried on the drying cylinder without overall mechanical compaction of the web. The web is then creped from the drying cylinder with a doctor blade, the doctor blade having an impact angle of from about 90 degrees to about 130 degrees. Thereafter the dried web is reeled at a fourth velocity, V₄, that is faster than the third velocity, V₃, of the drying cylinder.

The resulting paper has a plurality of formed features with discrete densified areas and pillow regions within the area occupied by the discrete densified areas.

### EXAMPLE 2

The same papermaking process of Example 1 is employed with a different patterned belt. In this embodiment, the transfer/imprinting fabric comprises a framework comprises a photosensitive resin, and a reinforcing element that is a fluid-permeable, woven fabric. The sheet side of the transfer/imprinting fabric consists of a continuous, patterned network of photopolymer resin, each discrete pillow region containing a discrete photopolymer resin element. The pillow regions have a surface area of about 0.020 in² and the discrete resin elements having an area of from about 0.003 in². The discrete pillow regions occupy about 50% of the surface area of the transfer/imprinting fabric. The polymer resin is supported by and attached to a woven reinforcing element having of 27.6 machine direction and 11.8 cross direction filaments per cm. The photopolymer network rises about 0.43 mm above the reinforcing element.

The resulting paper has a plurality of formed features with discrete pillow regions and densified regions within the area occupied by the discrete pillow regions.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A ply of a fibrous structure product comprising:
a continuous first pillow region,
a plurality of discrete densified regions;
wherein a first of the plurality of discrete densified regions forms a continuous hollow border area having at least one discrete second pillow region in the hollow border area;
wherein the area of the first discrete densified region is from about 0.006 in² to about 0.010 in²; and
wherein the area of the second pillow region has an area of from about 5% to about 50% of the area of the first discrete densified region.

2. The ply of fibrous structure product according to claim 1 wherein the area of the first discrete densified region is from about 0.004 in² to about 0.015 in².

3. The ply of fibrous structure product according to claim 2 wherein the area of the first discrete densified region is from about 0.001 in² to about 0.020 in².

4. The ply of fibrous structure product according to claim 1 wherein the area of the second pillow region is from about 10% to about 40% of the area of the discrete densified region.

5. The ply of fibrous structure product according to claim 4 wherein the area of the second pillow region is from about 20% to about 35% of the area of the discrete densified region.

6. The ply of fibrous structure product according to claim 1 wherein the basis weight is from about 10 lbs/3000 ft² to about 50 lbs/3000 ft².

7. The ply of fibrous structure product according to claim 6 wherein the basis weight is from about 20 lbs/3000 ft² to about 30 lbs/3000 ft².

8. A ply of a fibrous structure product comprising:
a continuous first densified region,
a plurality of discrete pillow regions;
wherein a first of the plurality of discrete pillow regions forms a continuous hollow border area having at least one discrete second densified region in the hollow border area;
wherein the area of the first discrete pillow region is from about 0.006 in² to about 0.010 in²; and
wherein the area of the second densified region has an area of from about 5% to about 50% of the area of the discrete pillow region.

9. The ply of fibrous structure product according to claim 8 wherein the area of the first discrete pillow region is from about 0.004 in² to about 0.015 in².

10. The ply of fibrous structure product according to claim 9 wherein the area of the first discrete pillow region is from about 0.001 in² to about 0.020 in².

11. The ply of fibrous structure product according to claim 8 wherein the area of the second densified region is from about 10% to about 40% of the area of the first discrete pillow region.

12. The ply of fibrous structure product according to claim 11 wherein the area of the second densified region is from about 20% to about 35% of the area of the discrete pillow region.

13. The ply of fibrous structure product according to claim 8 wherein the basis weight is from about 10 lbs/3000 ft² to about 50 lbs/3000 ft².

14. The ply of fibrous structure product according to claim 13 wherein the basis weight is from about 20 lbs/3000 ft² to about 30 lbs/3000 ft².
